(19) United States
(12) Patent Application Publication
(10) Pub. No.: US 2016/0130818 A1
(43) Pub. Date: May 12, 2016

(54) POWER-OPERATED AWNING WITH INTEGRAL POWER SOURCE

(71) Applicant: LIPPERT COMPONENTS, INC., Elkhart, IN (US)

(72) Inventor: Robert PLENCNER, Elkhart, IN (US)

(21) Appl. No.: 14/936,984

(22) Filed: Nov. 10, 2015

Related U.S. Application Data
(60) Provisional application No. 62/078,676, filed on Nov. 12, 2014.

(51) Int. Cl. E04F 10/06; H02P 1/22; E04H 15/58

(52) U.S. Cl. CPC E04F 10/0644; E04H 15/58; H02P 1/22

(57) ABSTRACT

A power-operated awning system includes an integral power supply including a battery and a battery charger housed in a power unit with a control switch. The power unit may be configured to have an appearance identical or similar to a base and arm of an awning support assembly.

### CROSS-REFERENCE TO RELATED APPLICATIONS

This application claims benefit of U.S. Provisional Patent Application No. 62/078,676, filed on Nov. 12, 2014, and incorporates by reference the disclosure thereof in its entirety.

### BACKGROUND AND SUMMARY OF THE DISCLOSURE

Awnings for recreational vehicles (RVs) and the like may be provided in power-operated or manually-operated form. Each has its advantages and disadvantages. Power-operated awnings may offer greater convenience than manually-operated awnings, but typically are more expensive. Manually-operated awnings may be relatively inexpensive than power-operated awnings, but they may require substantially more user interaction in their operation.

An RV provided with a manually-operated awning typically does not include power and control cables and control switches that would be required for operation and control of a power-operated awning. Adding such cabling and switches to an existing RV could involve substantially disassembly, modification, and reassembly of the RV. As such, doing so could be cost-prohibitive.

The disclosure shows and describes an illustrative power-operated awning having an integral power source. The power source may be a battery. The battery may be rechargeable. A charger and power cable may be provided for recharging the battery. The battery, control circuitry, and a control switch may be integrated into a support arm for the awning.

### BRIEF DESCRIPTION OF THE DRAWINGS

FIG. 1 is a view of an illustrative awning system and power unit attached to a wall, with the awning in a collapsed position;

FIG. 2 is a view of the awning system of FIG. 1 further including an awning fabric attached to the a roller, with the awning system in an extended position;

FIG. 3 is a perspective view of a base of a support assembly of the awning system of claim 1;

FIG. 4 is an end view of the base of FIG. 3;

FIG. 5 is a perspective view of a support arm of a support assembly of the awning system of claim 1;

FIG. 6 is an end view of the support arm of FIG. 5;

FIG. 7 is a perspective view of the power unit of FIG. 1 showing a base and a cover installed on the base;

FIG. 8 is a top plan view of the power unit of FIG. 1 with the cover removed;

FIG. 9 is a top plan view of the power unit of FIG. 1 with the cover installed on the base;

FIG. 10 is a side elevation view of the power unit of FIG. 1 with the cover installed on the base;

FIG. 11 is an end elevation view of the power unit of FIG. 1 with the cover installed on the base;

FIG. 12 is an end cross-sectional view of the power unit of FIG. 1 with the cover removed; and

FIG. 13 is another end cross-sectional view of the power unit of FIG. 1 with the cover removed.

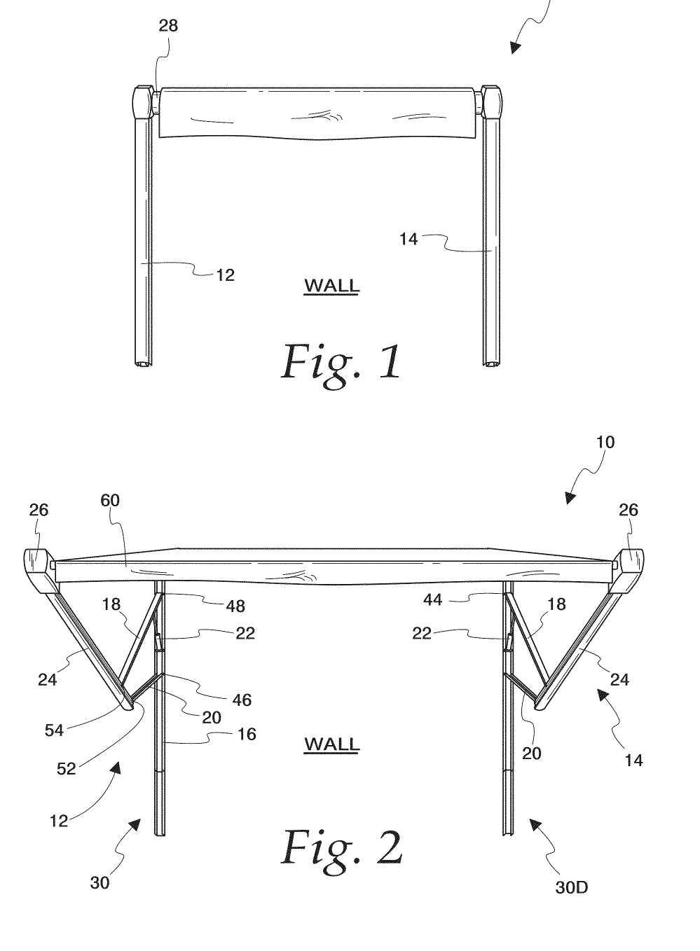

### DETAILED DESCRIPTION OF THE DRAWINGS

References to orientation, for example, upper, lower, and the like, herein should be construed as references to relative orientation of elements described in connection therewith and not absolute orientation unless context dictates otherwise.

The drawings show an illustrative power-operated awning system with integrated power supply 10. The awning system 10 includes a first support assembly 12 and a second support assembly 14. The second support assembly 14 may be identical to or the minor image of the first support assembly 12, except as noted.

The first support assembly 12 includes a base 16 having a first end and a second end. The base 16 is mountable to a wall of a structure, for example, a side wall of a recreational vehicle. A first end of a first support arm 18 is pivotally connected to the base 16 at a first pivot point 44 proximate the first end of the base. A first end of a second support arm 20 is pivotally connected to the base 16 at a second pivot 46 point proximate the first end of the base and between the first pivot point and the second end of the base. A first end of a telescopic actuator 22 is pivotally connected to the first support arm 18 at a third pivot point 48 proximate the first end thereof. As shown, a second end of the telescopic actuator 22 is pivotally connected to the base 16 at a fourth pivot point 50 between the first pivot point 44 and the second pivot point 46. Alternatively, the second end of the telescopic actuator 22 could be pivotally connected to the second support arm 20 at a fourth pivot point 50 proximate the first end thereof and between the second pivot point 46 and the second end thereof. A second end of the second support arm 20 is pivotally connected to a first end of a third support arm 24 at a fifth pivot point 52 proximate a first end of the third support arm. A second end of the first support arm 18 is pivotally connected to the third support arm 24 at a sixth pivot point 54 between the fifth pivot point 52 and a second end of the third support arm. The first, second and third support arms 18, 20, 24 may be selectively extended from the base 16 to a deployed position and collapsed against the base to a stowed position.

A head unit 26 is located proximate the second end of the third support arm 24. A roller tube 28 is disposed between the head units 26 of the first and second support assemblies 12, 14. The head unit 26 of either or both of the first and second support assemblies 12, 14 includes an electric motor configured to selectively rotate the roller tube 28 in both directions. An awning fabric 60 is connected between the roller tube 28 and the wall of the vehicle or other structure. The awning fabric 60 may be connected at or near a first end thereof to the wall of the vehicle or other structure or to an intervening bracket or the like. The awning fabric 60 may be connected at or near a second end thereof to the roller tube 28.

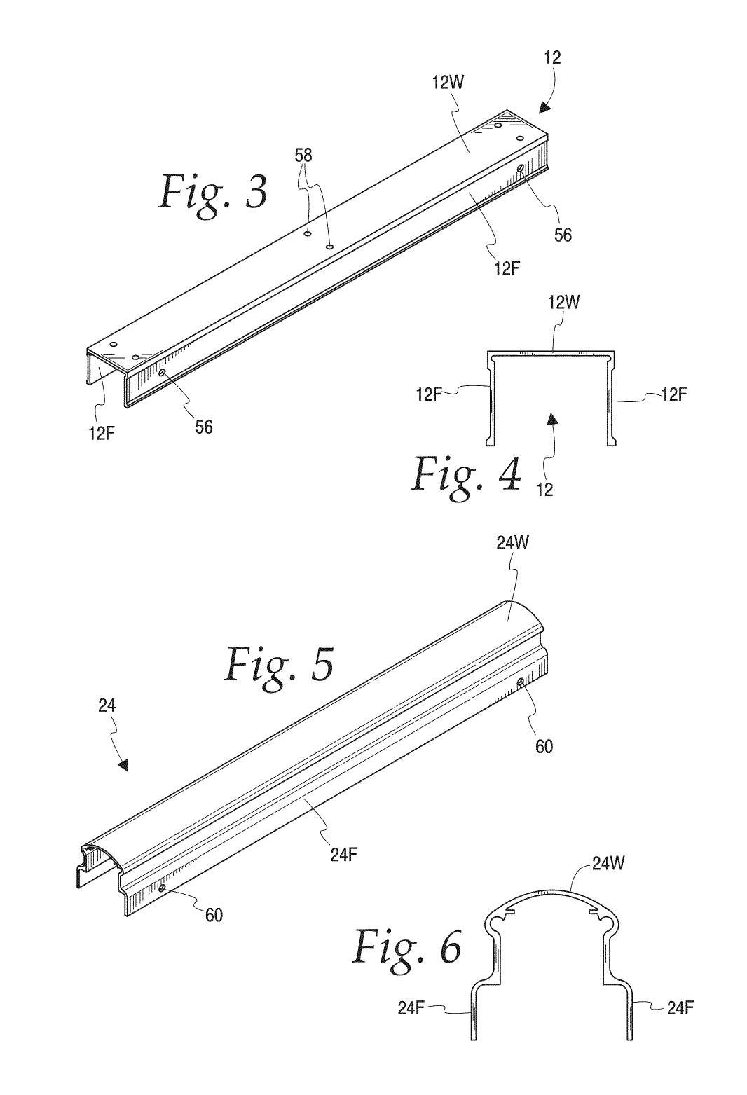

The base 16 of the support assembly 12, as best shown in FIGS. 3 and 4, may be a channel member having a web 16W and first and second parallel flanges 16F extending from the web. Pivot pin apertures 56 may be provided in the flanges 16F for receiving pivot pins (not shown) for pivotally connecting the first and second support arms 18, 20 thereto, and mounting hardware apertures 58 may be provided in the web 16W for receiving fasteners (not shown) for securing the base 16 to the wall. The base 16 could be configured in other suitable manners, as well. The base 16 could be an aluminum extrusion or be formed otherwise and/or of other material.

The third support arm 24, as best shown in FIGS. 5 and 6 may be configured as a form of channel having a particular cross-sectional configuration. The configuration may include a pair of generally parallel, minor image, shaped flanges 24F extending from a curved web 24W. The flanges 24F may include apertures 60 for receiving pivot pins for pivotally connecting the first and second support arms 18, 20 thereto. When the third support arm 24 is assembled to the base 16, the flanges 24F of the third support arm may be disposed outboard of the flanges 16F of the base.

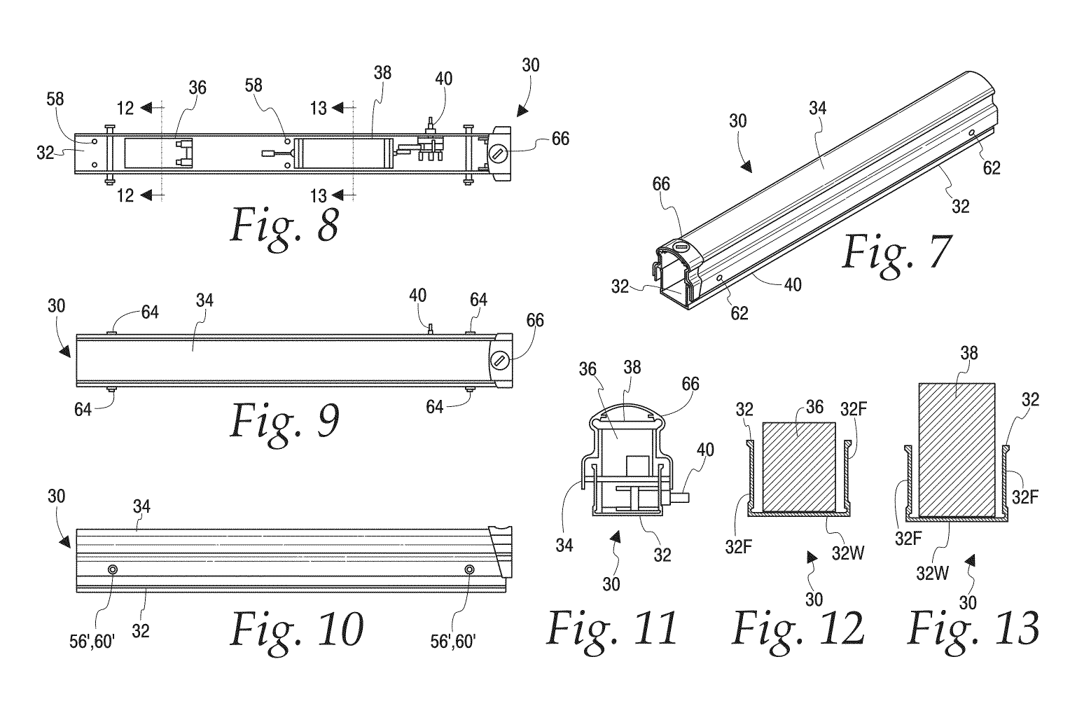

A power unit 30 is attached to the wall generally coextensive with one of the first and second support assembly 12, 14. The power unit 30 may include a base 32 having a cross section similar or identical to that of the base 16 and a cover 34 having a cross section similar or identical to that of the third support arm 24. For example, the base 32 of the power unit 30 may include a web 32W and flanges 32F analogous, respectively, to the web 16W and flanges 16F of the base 16 of the first or second support assembly 12, 14. Similarly, the cover 34 of the power unit 30 may include a web 34W and flanges 34F analogous, respectively, to the web 24W and flanges 24F of the third support arm 24 of the first or second support assembly 12, 14. An end cap 66 may be provided at one or both ends of the base 32 and/or cover 34 to mitigate against intrusion of moisture and contaminants into the power unit 30 (FIGS. 7 and 11 show the end surface of the end cap 66 removed so that the interior of the power unit 30 may be seen). Seals and/or gasketing (not shown) may be provided between the base 32 and cover 34 and otherwise, as desired, to further mitigate against intrusion of moisture and contaminants into the power unit 30.

The power unit 30 may enclose a power supply, for example, a battery 36, a battery charger 38, a control switch 40 and power and control wiring (not shown) connected among the battery, the battery charger, the control switch, and the awning motor (not shown). More particularly, the battery 36, charger 38, and control switch 40 may be attached to or otherwise, disposed upon the base 32, and the wiring may be enclosed within the base 32 or within the base 32 and cover 34. The control switch 40 may be a three-position switch having first and second “ON” positions and an intermediate “OFF” position. The first and second “ON” positions may be momentary contact positions, with the switch normally biased to the “OFF” position.

The base 32 of the power unit 30 may be attached to the wall so that the base 32 of the power unit 30 is generally collinear and coextensive with the base 16 of the corresponding support assembly 12, 14. The cover 34 may be attached to the base 32 using pins 62 or other fasteners extending through corresponding apertures 56′, 60′ in the respective flanges of the base and the cover so that the cover is generally collinear and coextensive with the corresponding third support arm 24 when the awning system 10 is in the collapsed position. So configured, the base 32 of the power unit 30 and the base 16 of the corresponding awning support assembly 12, 14, may appear as a single unit. Similarly, the cover 34 of the power unit 30 and the third support arm 24 may appear as a single unit when the awning system is collapsed. In an embodiment, the base 32 of the power unit 30 may be integral with the base 16 of the corresponding support assembly 12, 14.

A power cable (not shown) may extend from the battery 36 or elsewhere from the power unit 30, via the base 16, the first or second support arm 18, 20, and the third support arm 24, to the electric motor in the head unit 26 of the corresponding support assembly 12, 14.

A cord (not shown) may be provided to selectively connect the battery charger 38 to a suitable external power source, for example, a conventional electrical receptacle as might be found inside or on the outside of the RV, a garage, a power station, or elsewhere. The cord may be permanently attached to the charger 38 and stored in the power unit 30 when not in use. Alternatively, the cord may be removable from the charger 38.

A dummy power unit 30D may be attached to the wall generally collinear and coextensive with the other of the first and second support assembly 12, 14. The dummy power unit 30D may comprise a base 32 and cover 34 identical to the base 32 and cover 34 of the power unit 30, but lack the battery, charger, wiring and wiring of the power unit 30. In an embodiment, the base 32 of the dummy power unit 30D may be integral with the base 16 of the corresponding support assembly 12, 14.

In operation, a user may deploy (or extend) the awning 10 from a collapsed (or retracted) position by placing the control switch 40 into the first “ON” position, thereby energizing the motor to rotate in a first direction to unfurl the awning fabric 60 from the roller tube 28. The user may collapse (or retract) the awning 10 from a deployed (or extended) position by placing the control switch 40 into the second “ON” position, thereby energizing the motor to rotate in a second direction to roll the awning fabric 60 onto the roller tube 28. As set forth above the control switch 40 may be spring loaded or otherwise biased or configured to default to the “OFF” position, in which the motor is de-energized.

The awning 10 can be cycled repeatedly between deployed and collapsed positions on battery power until the battery 36 dies. The charger 30 can be used as desired to recharge the battery 36. In an embodiment, the awning 10 can be cycled indefinitely between deployed and collapsed positions while the charger 30 is connected to a suitable power source.

The awning system 10 can be retrofitted to a vehicle having a manually-operated awning or no awning at all with limited effort and little or no disruption of the vehicle. Manually-operated awnings typically having longer bases 16 than power-operated awnings. The power unit 30 and dummy power unit 30D typically would be installed on wall space vacated by replacement of a manually-operated awning with a power-operated awning and would cover mounting holes that might be abandoned upon removal of the manually-operated awning.

Dimensions shown in the drawings are illustrative and not limiting. The power-operated awning shown is illustrative and not limiting. The power unit disclosed herein could be used in connection with other types of power-operated awnings.

The embodiments disclosed herein are illustrative and could be modified without departure from the scope of the appended claims.

1. An awning system comprising:
a first support assembly comprising:
a first base configured for attachment to a structure;
a first head unit comprising a bidirectional electric motor; and
at least one first support arm connected between said first base and said first head unit, said at least one first support arm reconfigurable between an extended position in which said at least one first support arm is extended from said first base and a collapsed position in which said at least one first support arm is collapsed against said first base;
a second support assembly comprising:
a second base configured for attachment to said structure;
a second head unit; and
at least one second support arm connected between said second base and said second head unit, said at least one second support arm reconfigurable between an extended position in which said at least one second support arm is extended from said second base and a collapsed position in which said at least one second support arm is collapsed against said second base;
a roller tube connected between said first head unit and said second head unit in engagement with said motor; and
a power supply comprising:
a third base configured for attachment to said structure coextensive with said first base;
a battery disposed on said third base;
a battery charger disposed on said third base;
a three-position control switch disposed on said third base; and
a cover configured for selective attachment to said third base coextensive with said at least one first support arm when said at least one first support arm is in said collapsed position; and
a power cable electrically connecting said battery to said motor.

2. The awning system of claim 1 further comprising an awning fabric having a first end and a second end, said awning fabric connected to said roller tube proximate said first end.

3. The awning system of claim 1, said power supply further comprising a power cord having a first end connectable to said battery charger and a second end connectable to a source of external power.

4. The awning system of claim 3 wherein said first end of said cord is permanently attached to said battery charger.

5. The awning system of claim 1 further comprising a dummy power supply comprising a fourth base configured for attachment to said structure coextensive with said second base and a cover attachable to said fourth base coextensive with said at least one second support arm when said at least one second support arm is in said collapsed position.

6. The awning system of claim 5 wherein said cover of said power supply, said cover of said dummy power supply, said least one first support arm and said at least one second support arm have substantially identical longitudinal cross-sections.

7. The awning system of claim 6 wherein said cover of said power supply, said cover of said dummy power supply, said least one first support arm and said at least one second support arm are substantially identical extrusions.

8. The awning system of claim 1 wherein said cover and said at least one support arm have substantially identical longitudinal cross-sections.

9. The awning system of claim 8 wherein said cover and said at least one support arm are substantially identical extrusions.

10. The awning system of claim 1 wherein said first, second, and third bases have substantially identical longitudinal cross-sections.

11. The awning system of claim 5 wherein said first, second, third, and fourth bases have substantially identical longitudinal cross-sections.

12. A method of replacing a manually-operated awning having first and second roller tube support assemblies fitted to a recreational vehicle with a power-operated awning, comprising:
removing said manually-operated awning from said recreational vehicle;
providing a power-operated awning system comprising:
a first roller tube support assembly comprising:
a first base configured for attachment to said recreational vehicle;
a first head unit comprising a bidirectional electric motor; and
at least one first support arm connected between said first base and said first head unit, said at least one first support arm reconfigurable between an extended position in which said at least one first support arm is extended from said first base and a collapsed position in which said at least one first support arm is collapsed against said first base;
a second roller tube support assembly comprising:
a second base configured for attachment to said recreational vehicle;
a second head unit; and
at least one second support arm connected between said second base and said second head unit, said at least one second support arm reconfigurable between an extended position in which said at least one second support arm is extended from said second base and a collapsed position in which said at least one second support arm is collapsed against said second base;
a roller tube connected between said first head unit and said second head unit in engagement with said motor; and
a power supply comprising:
a third base configured for attachment to said recreational vehicle coextensive with said first base;
a battery disposed on said third base;
a battery charger disposed on said third base;
a three-position control switch disposed on said third base; and
a cover configured for selective attachment to said third base coextensive with said at least one first support arm;
a dummy power unit comprising:
a fourth base configured for attachment to said recreational vehicle coextensive with said second base; and
a cover configured for selective attachment to said fourth base coextensive with said at least one second support arm; and
a power cable electrically connecting said battery to said motor; and
attaching said first base, said second base, and said third base, and said fourth base of said power-operated awning to said recreational vehicle such that said first base, said second base, said third base, and said fourth base cover all mounting holes in said recreational vehicle that were used to attach said first and second roller tube support assemblies of said manually-operated awning to said recreational vehicle.

13. The method of claim 12 further comprising electrically connecting said battery to said motor.

14. The method of claim 12 further comprising installing said roller tube between said first head unit and said second head unit.

15. A method of providing power to a power-operated awning installed on a recreational vehicle, the power-operated awning comprising:
a first support assembly comprising:
a first base configured for attachment to said recreational vehicle;
a first head unit comprising a bidirectional electric motor; and
at least one first support arm connected between said first base and said first head unit, said at least one first support arm reconfigurable between an extended position in which said at least one first support arm is extended from said first base and a collapsed position in which said at least one first support arm is collapsed against said first base;
a second support assembly comprising:
a second base configured for attachment to said recreational vehicle;
a second head unit; and
at least one second support arm connected between said second base and said second head unit, said at least one second support arm reconfigurable between an extended position in which said at least one second support arm is extended from said second base and a collapsed position in which said at least one second support arm is collapsed against said second base; and
a roller tube connected between said first head unit and said second head unit in engagement with said motor;
the method comprising:
providing a power supply comprising:
a third base configured for attachment to said recreational vehicle coextensive with said first base;
a battery disposed on said third base;
a battery charger disposed on said third base;
a three-position control switch disposed on said third base; and
a cover configured for selective attachment to said third base coextensive with said at least one first support arm;
attaching said base to said recreational vehicle coextensive with said first base;
attaching said cover of said power supply to said third base; and
electrically connecting said battery to said motor.

16. The method of claim 15 further comprising the step of providing a dummy power supply comprising a fourth base configured for attachment to said recreational vehicle coextensive with said second base and a cover attachable to said fourth base coextensive with said at least one second support arm; and
attaching said cover of said dummy power supply to said fourth base.

17. The method of claim 15 further comprising the step of connecting a power cord between said battery charger and a source of external power.

18. An awning system comprising:
a first support assembly comprising:
a first base configured for attachment to a structure;
a first head unit comprising a bidirectional electric motor; and
at least one first support arm connected between said first base and said first head unit, said at least one first support arm reconfigurable between an extended position in which said at least one first support arm is extended from said first base and a collapsed position in which said at least one first support arm is collapsed against said first base;
a second support assembly comprising:
a second base configured for attachment to said structure;
a second head unit; and
at least one second support arm connected between said second base and said second head unit, said at least one second support arm reconfigurable between an extended position in which said at least one second support arm is extended from said second base and a collapsed position in which said at least one second support arm is collapsed against said second base;
a roller tube connected between said first head unit and said second head unit in engagement with said motor; and
a power supply integrated into said first base, said power supply comprising:
a battery;
a battery charger;
a three-position control switch; and
a cover configured for selective attachment to said first base coextensive with said at least one first support arm; and
a power cable electrically connecting said battery to said motor.
